(19) United States
(12) Patent Application Publication
(10) Pub. No.: US 2026/0238641 A1
(43) Pub. Date: Aug. 13, 2026

(54) IDENTIFYING ATTACKERS BY USING BEHAVIORAL BIOMETRICS AND MACHINE LEARNING

(71) Applicant: ARKOSE LABS HOLDINGS, INC., San Mateo, CA (US)

(72) Inventors: Luke Stork, San Mateo, CA (US); Filip Dobosz, San Mateo, CA (US); Ashish Mittal, San Mateo, CA (US); Vikas Shetty, San Mateo, CA (US)

(21) Appl. No.: 19/049,588

(22) Filed: Feb. 10, 2025

(51) Int. Cl. H04L 9/40

(52) U.S. Cl. CPC H04L 63/0861; H04L 63/1416

(57) ABSTRACT

A system and method of using behavioral biometrics and machine learning to identify attackers in a computing environment. The method includes receiving a request to authenticate a user of a client device that is requesting access to a webpage. The method includes providing a security puzzle to the client device. The method includes acquiring an input dataset corresponding to a plurality of behavioral biometrics associated with an attempt by the user of the client device to solve the security puzzle. The method includes providing the input dataset to a classification platform trained to classify users of client devices as being human users or bot users based on behavioral biometrics. The method includes generating a report indicating whether the user of the client device is a human user or a bot user.

### TECHNICAL FIELD

The present disclosure relates generally to Artificial Intelligence (AI), and more particularly, to systems and methods using behavioral biometrics and machine learning to identify attackers in a computing environment.

### BACKGROUND

Cybersecurity is the practice of protecting critical systems and sensitive information from digital attacks. Cybersecurity techniques are designed to combat threats against networked systems and applications, whether those threats originate from inside or outside of an organization. AI can significantly enhance cybersecurity by automating threat detection, analyzing vast amounts of data for patterns indicative of cyber threats, and responding to incidents in real-time. Machine learning algorithms can identify anomalies and potential vulnerabilities that might be missed by human analysts, while AI-driven systems can adapt to new threats by learning from past incidents. Additionally, AI can help in predicting and preventing cyber-attacks by continuously monitoring network traffic and user behavior, thus providing a proactive defense mechanism against evolving cyber threats.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for identifying attackers by using behavioral biometrics and machine learning, according to some embodiments;

FIG. 2A is a 3D block diagram of example biometric movement patterns of an solve service A bot as it interacts with a security puzzle, according to some embodiments;

FIG. 2B is a 3D block diagram of example biometric movement patterns of a solve service B bot as it interacts with a security puzzle, according to some embodiments;

FIG. 2C is a 3D block diagram of an example biometric movement pattern of a solve service C bot as it interacts with a security puzzle, according to some embodiments;

FIG. 3 is a block diagram depicting example incoming biometric data, according to some embodiments;

FIG. 4 is a block diagram depicting an example of preprocessed biometric data, according to some embodiments;

FIG. 5A is a block diagram depicting an example of the BBS system in FIG. 1, according to some embodiments;

FIG. 5B is a block diagram depicting an example of the host machine of the environment in FIG. 1, according to some embodiments;

FIG. 6 is a flow diagram depicting a method of using behavioral biometrics and machine learning to identify attackers in a computing environment, according to some embodiments; and

FIG. 7 is a block diagram of an example computing device that may perform one or more of the operations described herein, in accordance with some embodiments.

### DETAILED DESCRIPTION

In the evolving landscape of cybersecurity, there is an ever-increasing demand to identify and mitigate sophisticated attacks. Traditional security systems predominantly rely on capturing static data points from web browsers to detect malicious activities. These data points include Internet Protocol (IP) addresses, user-agent strings, and other network-level features that are often easily randomized by attackers using advanced Completely Automated Turing test to tell Computers and Human Apart (CAPTCHA) solving services and automated scripts. Despite the effectiveness of these services in obfuscating static data, attackers often overlook the nuances of their mouse movements and other biometric behaviors.

However, behavioral biometrics, which encompass patterns in human-computer interactions such as mouse dynamics, keystroke dynamics, and touch gestures, offer a promising avenue for distinguishing legitimate users from malicious entities. These biometric patterns, when visualized in a three-dimensional plane, reveal distinct characteristics that are inherently difficult to replicate by automated systems. For instance, human mouse movements tend to be smooth and continuous, whereas automated scripts often produce erratic or overly uniform patterns.

Different attacker groups, each exhibit unique biometric patterns that starkly contrast with those of genuine users as well as other forms of automation. A first attacker group might generate mouse movements with high precision and speed, while a second attacker group may display patterns with significant jitter and randomness. A third attacker group, on the other hand, might exhibit a combination of both approaches, creating a unique biometric signature that still fails to mimic human behavior accurately. However, manually reviewing these patterns for millions of sessions is impractical.

Furthermore, given the attacker's ability to easily manipulate static features, it becomes highly likely for malicious code to be deployed and permitted to run in a computing environment (e.g., private network, corporate network, and/or the like), which consequently, introduces a plethora of security vulnerabilities that could degrade the computing environment and lead to a waste of computing resources (e.g., memory, storage, processing, and/or networking). Thus, there is a long-felt, unsolved need for an advanced detection method that leverages the richness of behavioral biometric data to detect these malicious attacks against a computing environment.

Although the present disclosure refers to cursor events in describing the present embodiments, any of the present embodiments may be modified to classify users of client devices as being human users or bot users based on any type of behavioral biometrics, such as, cursor events, touch events, events from mobile device sensors, and/or the like.

Aspects of the present disclosure address the above-noted and other deficiencies by providing a mechanism to identify attackers by using behavioral biometrics and machine learning. The present disclosure addresses the development of a sophisticated detection system that integrates behavioral biometrics with machine learning algorithms. By capturing and analyzing detailed biometric data from legitimate users and attacker, where the biometric data is indicative of user interactions, the disclosed system can accurately differentiate between legitimate users and various types of attackers. The present disclosure provides machine learning models that are trained using extensive datasets of known biometric patterns, enabling them to accurately classify and detect potential threats in real-time. The integration of machine learning not only enhances the system's detection capabilities, but also allows it to continuously learn and adapt to emerging attack patterns, thereby improving its accuracy and effectiveness over time.

This innovative approach transcends traditional cybersecurity methods that primarily rely on static data points, which are easily manipulated by attackers. By focusing on dynamic and intricate biometric behaviors such as mouse movements, keystroke dynamics, and touch gestures, the system provides a more robust and reliable means of identifying malicious actors.

In essence, this disclosure introduces a novel cybersecurity solution that harnesses the power of behavioral biometrics and machine learning to offer a resilient and adaptive defense mechanism. This approach not only addresses the limitations of existing security systems, but also sets a new standard for future advancements in protecting online interactions from sophisticated threats. By continuously evolving and adapting to new attack vectors, the proposed system ensures a higher level of security and trust in digital environments.

The solution of the present disclosure differentiates from prior behavioral biometrics based bot detection implementations in at least the following ways. First, for example, the trained machine learning model is able to uniquely identify biometric signatures of specific bots or automated systems that are differentiable from other automated systems, botnets, and humans. This method of uniquely identifying (e.g., fingerprinting) behavioral biometric signatures of automated systems is done within the context of a CAPTCHA, but could also extend beyond this context to other digital interactions like web interfaces, mobile applications, and any environment with a human computer interface. This approach is described in the context of mouse cursor based behavioral biometrics, but can be extended to other areas of behavioral biometrics including, for example, touch screen interactions, keypress events, and motion sensor data.

Second, for example, combining features derived from behavioral biometric interactions with network properties (e.g., information on internet service providers etc.) and language based features (e.g., default and preferred browser languages) creates a more accurate and unique signal to better identify automated systems.

Third, for example, the method of processing behavioral biometric data and the specific features and approach to developing a machine learning classifier may be unique and offer an improvement upon other existing behavioral biometric anomaly detection approaches.

In an illustrative embodiment, a behavioral biometric security (BBS) system receives a request to authenticate a user of a client device that is requesting access to a webpage. The BBS system provides a security puzzle (e.g., a CAPTCHA challenge) to the client device responsive to receiving the request. The BBS system acquires an input dataset corresponding to a plurality of mouse events associated with an attempt by the user of the client device to solve the security puzzle. The input dataset includes at least one of a plurality of mouse positions, a plurality of mouse click statuses, and a plurality of timestamps associated with the plurality of mouse events. The BBS system provides the input dataset to a classification platform trained to classify users of client devices as being human users or bot users based on mouse events. The BBS system generates, using the classification platform, a report indicating whether the user of the client device is a human user or a bot user.

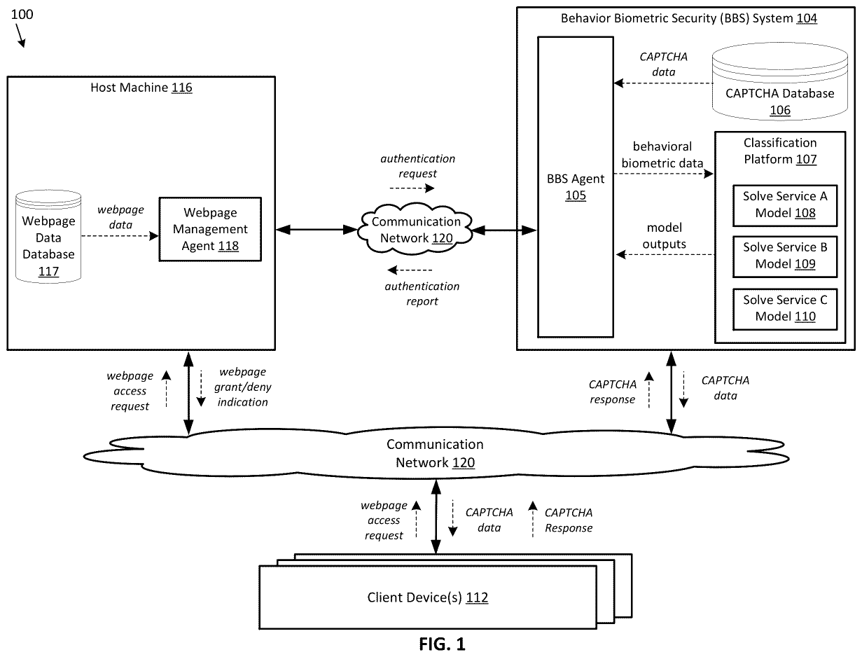

FIG. 1 is a block diagram depicting an example environment for identifying attackers by using behavioral biometrics and machine learning, according to some embodiments. The environment 100 includes a behavioral biometric security (BBS) system 104, one or more client devices 102, and a host machine 116 that are each communicably coupled together via a communication network 120. The BBS system 104 includes and/or executes a BBS agent and a CAPTCHA database that includes a plurality of different types of CAPTCHA challenges (e.g., security puzzles).

The BBS system 104 also includes and/or executes a classification platform 107 that includes a plurality of predicative and/or AI models that are trained to classify users of client devices as being human users or bot users based on mouse events. Specifically, the classification platform 107 includes and/or executes a solve service A model 108, a solve service B 109, and a solve service C model 110. The BBS agent 105 trains, using a first set of training data, the solve service A model 108 to determine whether an input dataset includes biometric movement patterns that are indicative of a solve service A bot, and generate an output value (e.g., 0 or 1, no or yes) indicating its determination. The BBS agent 105 trains, using a second set of training data, the solve service B 109 to determine whether an input dataset includes biometric movement patterns that are indicative of a solve service B bot, and generate an output value (e.g., 0 or 1, no or yes) indicating its determination. The BBS agent 105 trains, using a third set of training data, the solve service C model 110 to determine whether an input dataset includes biometric movement patterns that are indicative of a solve service C bot, and generate an output value (e.g., 0 or 1, no or yes) indicating its determination. The first set of training data includes biometric movement data produced by a solve service A bot, the second set of training data includes biometric movement data produced by a solve service B bot, and the third set of training data includes biometric movement data produced by a solve service C bot.

The host machine 116 includes and/or executes a webpage management agent 118 that hosts one or more webpages that are locally stored in its webpage data database 117.

The communication network 120 may be a public network (e.g., the internet), a private network (e.g., a local area network (LAN) or wide area network (WAN)), or a combination thereof. In one embodiment, communication network 120 may include a wired or a wireless infrastructure, which may be provided by one or more wireless communications systems, such as wireless fidelity (Wi-Fi) connectivity to the communication network 120 and/or a wireless carrier system that can be implemented using various data processing equipment, communication towers (e.g., cell towers), etc. The communication network 120 may carry communications (e.g., data, message, packets, frames, etc.) between any other the computing device.

The BBS system 104, host machine 116, and client device 112 may each be any suitable type of computing device or machine that has a processing device, for example, a server computer (e.g., an application server, a catalog server, a communications server, a computing server, a database server, a file server, a game server, a mail server, a media server, a proxy server, a virtual server, a web server), a desktop computer, a laptop computer, a tablet computer, a mobile device, a smartphone, a set-top box, a graphics processing unit (GPU), etc. In some examples, a computing device may include a single machine or may include multiple interconnected machines (e.g., multiple servers configured in a cluster).

Still referring to FIG. 1, the host machine 116 receives, from the client device 112, a webpage access request to access a webpage that is hosted by the host machine 116. In response to receiving the request, the host machine 116 sends, to the BBS system 104, an authentication request to authenticate a user of the client device 112. The BBS system 104 provides a security puzzle (e.g., CAPTCHA data) to the client device 112 responsive to receiving the request. The BBS system 104 acquires an input dataset corresponding to a plurality of mouse events associated with an attempt by the user of the client device 112 to solve the security puzzle. For example, the BBS system 104 receives a CAPTCHA response from the client device 112 and extracts the input dataset (e.g., biometric data indicative of mouse events) from the CAPTCHA response. The input dataset includes at least one of a plurality of mouse positions, a plurality of mouse click statuses, and a plurality of timestamps associated with the plurality of mouse events. The BBS system 104 provides the input dataset to the classification platform 107 that includes a plurality of models (e.g., solve service A model 108, solve service B 109, and solve service C 110) that are each trained to classify users of client devices 112 as being human users or bot users based on mouse events. The BBS system 104 generates, using the classification platform 107, an authentication report indicating whether the user of the client device 112 is a human user or a bot user and sends the authentication report to the host machine 116.

The host machine 116 can decide, based on the authentication report, whether to grant the client device 112 access to the requested webpage or deny the client device 112 from accessing the webpage. If the host machine 116 grants access, then the host machine 116 send the webpage to the client device 112. However, if the host machine denies access, then the host machine 116 does not send the webpage to the client 112, and instead sends an indication to the client device 112 indicating that the client device 112 does not have permission to access the webpage.

Although FIG. 1 shows only a select number of computing devices (e.g., BBS system 104, host machine 116, and client devices 112), the environment 100 may include any number of computing devices that are interconnected in any arrangement to facilitate the exchange of data between the computing devices.

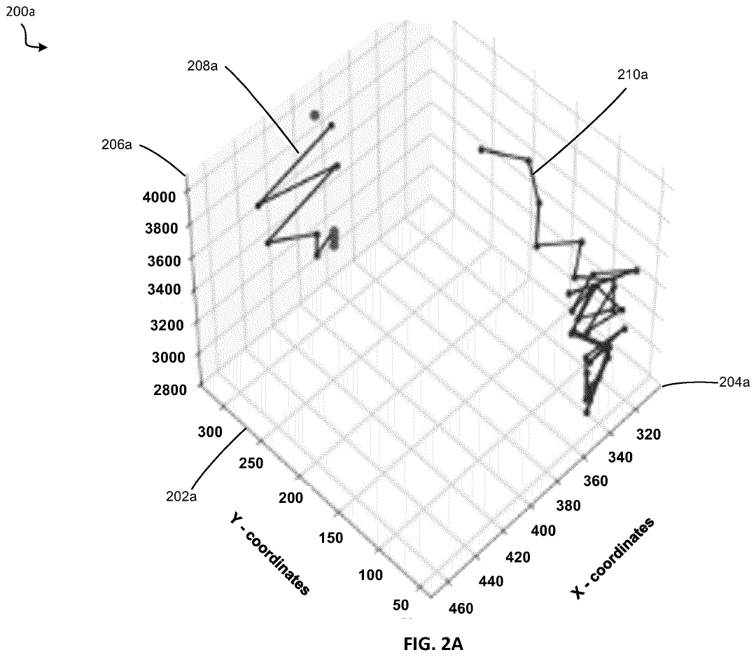

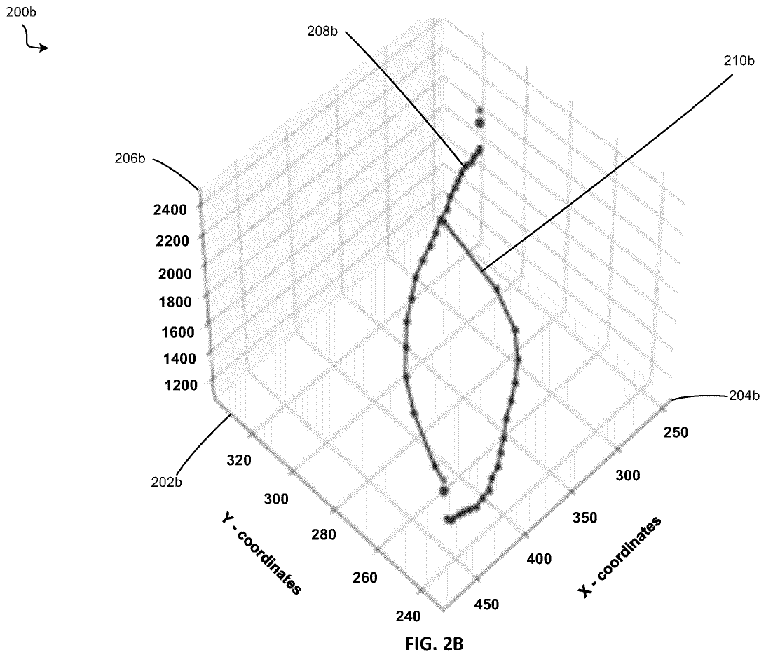

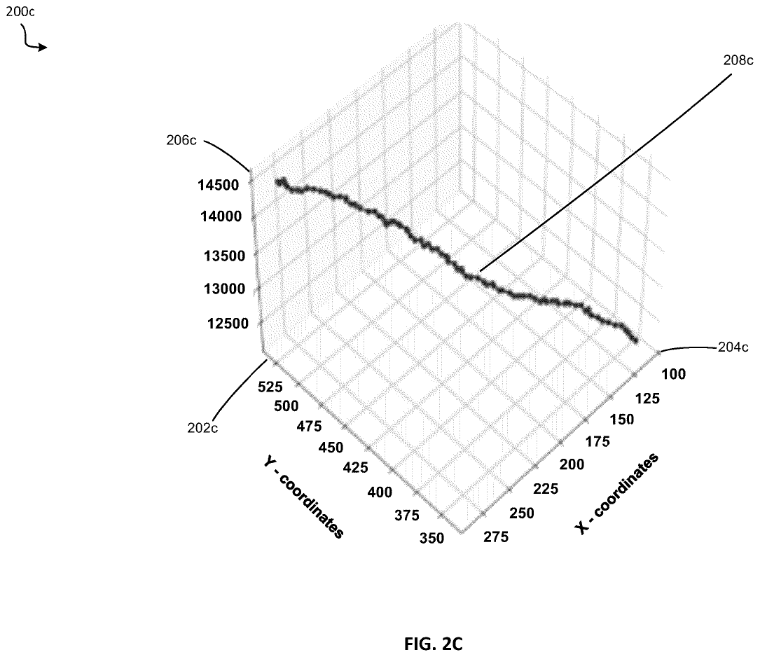

FIGS. 2A-C are three-dimensional (3D) block diagrams depicting example biometric movement patterns of different bots during their interaction with a security puzzle (e.g., CAPTCHA). For example, FIG. 2A is a 3D block diagram of example biometric movement patterns of solve service A bot as it interacts with a security puzzle, according to some embodiments. The diagram 200a includes a biometric movement pattern 208 and biometric movement pattern 210a, each relative to an x-axis 202a, a y-axis 204a, and a z-axis 206a.

FIG. 2B is a 3D block diagram of example biometric movement patterns of a solve service B bot as it interacts with a security puzzle, according to some embodiments. The diagram 200b includes a biometric movement pattern 208a and biometric movement pattern 210b, each relative to an x-axis 202b, a y-axis 204b, and a z-axis 206b.

FIG. 2C is a 3D block diagram of an example biometric movement pattern of a solve service C bot as it interacts with a security puzzle, according to some embodiments. The diagram 200c includes a biometric movement pattern 208c, relative to an x-axis 202c, a y-axis 204c, and a z-axis 206c.

As shown FIGS. 2A-C, each attacker exhibits distinct click patterns, movement speeds, and direction changes. Behavioral biometrics, specifically mouse movement patterns, are captured when users or bots interact with our puzzles. By analyzing these interaction patterns, the BBS system 104 can effectively distinguish between legitimate and illegitimate traffic. That is, the creation of features that encapsulate this information is fundamental to the success of these models. These features enable the disclosed machine learning models to accurately identify and respond to malicious activity, ensuring the integrity and security of the computing system and network.

The BBS system 104 captures biometric data (e.g., raw data) during user or bot interactions with one or one or more security puzzles (e.g., CAPTCHA). As shown in FIGS. 2A-C, the biometric data includes mouse biometrics indicating X and Y coordinates of mouse movements, as well as mouse click events. For example, the mouse biometrics may indicate whether the mouse was clicked up, the mouse was clicked down, or that there was no mouse click event during a particular time period.

In addition to mouse biometrics, the BBS system 104 leverages Internet Service Provider (ISP) information and HTTP_ACCEPT_LANGUAGE headers for feature engineering. Incorporating these features enhances the intelligence and accuracy of our machine learning models, allowing for more effective detection of malicious activities.

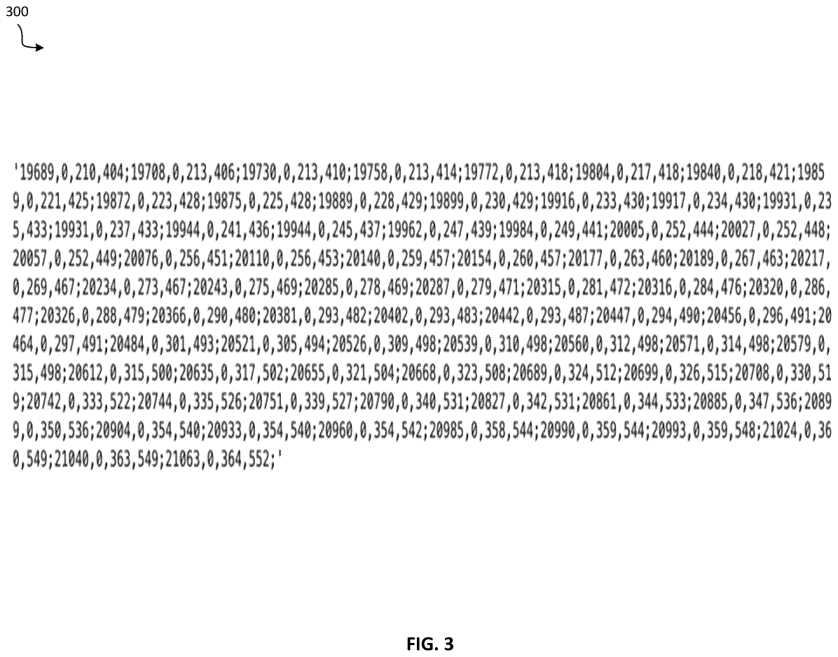

FIG. 3 is a block diagram depicting example incoming biometric data, according to some embodiments. As shown, the incoming biometric data is received as a string separated by semicolons. Each segment of the string includes one or more of the following: a timestamp, which is the first element indicating the time of the event; a click status, which is the second element representing the mouse click status (e.g., 0 for no click, 1 for click down, 2 for click up); and X-coordinate, which is the third element representing the X-axis position of the mouse; and a Y-coordinate, which is the fourth element representing the Y-axis position of the mouse.

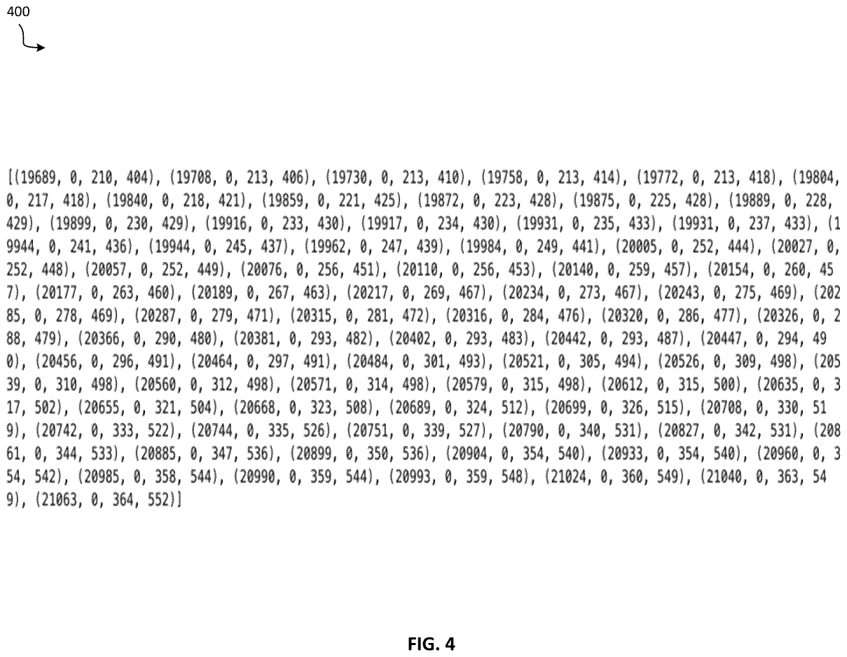

FIG. 4 is a block diagram depicting an example of preprocessed biometric data, according to some embodiments. That is, to facilitate efficient feature calculation, the biometric string (e.g., incoming biometric data) is first parsed and transformed into a list of tuples. Each tuple contains four elements corresponding to the timestamp, click status, X coordinate, and Y coordinate, respectively, as shown in FIG. 4. In some embodiments, the BBS system 104 processes the incoming biometric data according to the following operations. First, the BBS system 104 parses (e.g., splits) the biometric string using semicolons as delimiters (e.g., semicolon, comma, space, and/or the like). Each set of four consecutive elements are then grouped into a tuple. Second, the system, transforms the data into tuples. That is, the BBS system 104 organizes the parsed data into a list of tuples, each representing a unique mouse event. Third, the BBS system 104 performs efficient feature calculation. That is, the list of tuples is then utilized for further feature extraction and model training.

This preprocessing step converts the raw biometric string data into a structured format, thereby enabling more efficient and accurate calculation of biometric features. The BBS system 104 uses these features for training machine learning models to distinguish between legitimate users and potential attackers.

### Biometric Features:

The BBS system 104 can derive features from the biometric data. Below is a list of biometric features, along with their corresponding mathematical formulations.

Total Distance is the sum of distances between consecutive points. The BBS system 104 calculates this biometric feature according to the following equation:

$$Total Distance = \sum sqrt ( ( x\_ ( i + 1 ) - x\_i ) \hat{} 2 + ( y\_ ( i + 1 ) - y\_i ) \hat{} 2 )$$

Average Speed is calculated from the distances between points and the time intervals. The BBS system 104 calculates this biometric feature according to the following equation:

$$Average Speed = ( 1 / ( n - 1 ) ) * \sum ( d\_i / ( t\_ ( i + 1 ) - t\_i ) )$$

where d_i=sqrt((x_(i+1)−x_i)\hat{ }2+ (y_(i+1)−y_i)\hat{ }2)

Maximum Speed calculated between any two consecutive points. The BBS system 104 calculates this biometric feature according to the following equation:

$$Max Speed = max ( d\_i / ( t\_ ( i + 1 ) - t\_i ) )$$

Direction Changes is the number of significant changes in movement direction. The BBS system 104 calculates this biometric feature according to the following equation:

$$Direction Changes = \sum 1 ( \vert θ\_ ( i + 1 ) - θ\_i \vert > δ )$$

where θ_i=arctan 2(y_(i+1)−y_i, x_(i+1)−x_i) and δ is a predefined threshold.

Stop Duration is the total duration for which there is no movement. The BBS system 104 calculates this biometric feature according to the following equation:

$$Stop Duration = \sum 1 ( t\_ ( i + 1 ) - t\_i = 0 )$$

Acceleration is the average acceleration calculated from the changes in speed. The BBS system 104 calculates this biometric feature according to the following equation:

$$Acceleration = ( 1 / ( n - 2 ) ) * \sum ( ( s\_ ( i + 1 ) - s\_i ) / ( t\_ ( i + 2 ) - t\_ ( i + 1 ) ) )$$

where s_i=d_i/(t_(i+1)−t_i)

Path Efficiency is the ratio of the straight-line distance between the start and end points to the total distance traveled. The BBS system 104 calculates this biometric feature according to the following equation:

$$Path Efficiency = ( s q r t ( {( x\_n - x\_ 1 )}^{⋀} 2 + {( y\_n - y\_ 1 )}^{⋀} 2 ) ) / Total Distance$$

Angles of Movement is the average angle of movement between consecutive points. The BBS system 104 calculates this biometric feature according to the following equation:

$$Angles of Movement = ( 1 / ( n - 1 ) ) * \sum θ\_i$$

Speed Variability is the standard deviation of the speeds. The BBS system 104 calculates this biometric feature according to the following equation:

$$Speed Variability = sqrt ( ( 1 / ( n - 1 ) ) * \sum {( s\_i - \overline{s} )}^{⋀} 2 )$$

where s̅ is the average speed.

Click Time Variability is the standard deviation of the time intervals between clicks. The BBS system 104 calculates this biometric feature according to the following equation:

$$Click Time Variability = sqrt ( ( 1 / ( m - 1 ) ) * \sum {( t\_click \_ ( i + 1 ) - t\_click \_i - Δ \overline{t} )}^{⋀} 2 )$$

where t_click_i are the timestamps of click events, and Δt̅ is the average time interval between clicks.

Direction Consistency is a binary indicator of whether the movement is consistent in one direction. The BBS system 104 calculates this biometric feature according to the following equation:

$$Direction Consistency = 1 if Major Direction Changes < ( n - 2 ) / 4 else 0$$

Major Direction Changes is the number of direction changes greater than 90 degrees. The BBS system 104 calculates this biometric feature according to the following equation:

$$Major Direction Changes = \sum 1 ( \vert {θ}_{-} ( i + 1 ) - θ\_i \vert > π / 2 )$$

Interaction Length is the total number of recorded points.

Number of Clicks is the total number of mouse clicks. The BBS system 104 calculates this biometric feature according to the following equation:

$$Number of Clicks = \sum 1 ( click\_i \neq 0 )$$

Number of Click Ups is the total number of mouse click up events. The BBS system 104 calculates this biometric feature according to the following equation:

$$Number of Click Ups = \sum 1 ( click\_i = 1 )$$

Number of Click Downs is the total number of mouse click down events. The BBS system 104 calculates this biometric feature according to the following equation:

$$Number of Click Downs = \sum 1 ( click\_i = 2 )$$

Straight Line Distance is the Euclidean distance between the start and end points. The BBS system 104 calculates this biometric feature according to the following equation:

$$Straight Line Distance = sqrt ( {( x\_n - x\_ 1 )}^{⋀} 2 + {( y\_n - y\_ 1 )}^{⋀} 2 )$$

Bounding Box Width is the width of the bounding box containing all the points. The BBS system 104 calculates this biometric feature according to the following equation.

$$Bounding Box Width = max ( x\_i ) - min ( x\_i )$$

Bounding Box Height is the height of the bounding box containing all the points. The BBS system 104 calculates this biometric feature according to the following equation.

$$Bounding Box Height = max ( y\_i ) - min ( y\_i )$$

By implementing these formulations, the system efficiently extracts meaningful features from the biometric data, enabling robust and accurate detection of user behavior patterns. These features are integral to the machine learning models used to differentiate between legitimate users and potential attackers.

### Significance of Http_Accept_Language and ISP Fields

To enhance the model's capability in distinguishing between legitimate users and attackers, the BBS system 104 extracts and engineers features from the http_accept_language header and Internet Service Provider (ISP) information.

The http_accept_language header field indicates the preferred languages of the user agent (e.g., browser) as specified by the user. The BBS system 104 analyzes the structure and values of this header to detect the likelihood of automated scripts versus genuine human users. Attackers may not accurately simulate this behavior, leading to detectable anomalies.

The BBS system 104 can also analyze the ISP Information/Field to determine contextual information about the user's location and network. Certain ISPs may be more prone to malicious activities or known for high volumes of automated traffic. By mapping ISP popularity, the BBS system 104 can determine if the request comes from a common or rare ISP, aiding in the detection of suspicious behavior.

### Feature Calculation Methods

The BBS system 104 can perform an order check of the http_accept_language values to determine if the http_accept_language values are listed in a descending order based on their quality (q) factors, which indicate the user's preference levels. For example, the BBS system 104 may split the http_accept_language string by commas to separate different language preferences; check if there are any language preferences listed without a quality factor (q); if the list contains multiple languages, ensure that subsequent q values are in descending order; and return a flag indicating whether the order is correct (e.g., 1 for true, 0 for false).

The BBS system 104 can check the http_accept_language values to detect if quality scores (q values) are present in the http_accept_language header. For example, the BBS system 104 may check for the presence of the semicolon (;) character in the http_accept_language string; and return 1 if the quality score is present, otherwise return 0.

The BBS system 104 can map the ISP values to their popularity or frequency of occurrence. For example, use a predefined frequency map of ISPs to assign a popularity score to each ISP in the dataset; and replace missing ISP values with ‘missing’.

These features provide additional context and nuances to the machine learning models, improving their ability to detect and classify suspicious behaviors accurately. The descending order check and the presence of quality scores help in identifying inconsistencies or anomalies in the http_accept_language header, while the ISP popularity mapping adds contextual information regarding the user's network. By incorporating these engineered features, the system leverages additional data points that are often overlooked by attackers, enhancing the overall robustness and accuracy of the cybersecurity solution.

### Machine Learning Model Training

The present disclosure employs a supervised learning approach for model training, leveraging pre-labeled data that included various types of attackers. The BBS system 104 may include multiple models that are trained to specifically detect different types of attackers. In some embodiments, the multiple models may utilize a Light Gradient Boosting Machine (LightGBM) algorithm that includes the following characteristics. First, the LightGBM algorithm may exist high perform in that it consistently provides/produces optimal results when analyzing behavioral biometric data, and in some instance, outperforming other supervised learning algorithms. Second, the LightGBM algorithm exhibits optimal speed and efficiency when analyzing behavioral biometric data, where this optimal speed and efficiency are crucial for real-time detection systems. Third, the LightGBM algorithm is capable of handling large datasets with high-dimensional data efficiently, thereby making it well-suited for analyzing behavioral biometric data. Fourth, the LightGBM algorithm offers higher model accuracy through its ability to capture complex patterns in data by using advanced techniques, such as Gradient-based One-Side Sampling (GOSS) and Exclusive Feature Bundling (EFB).

In some embodiments, the hyperparameters for the LightGBM models may be fine-tuned using Bayesian optimization to achieve optimal performance. In some embodiments, Bayesian optimization may be employed due to its efficiency in finding the best hyperparameters by balancing exploration and exploitation, significantly reducing the time required for hyperparameter tuning compared to traditional grid search or random search methods.

An example configuration may include the following configuration: bagging_fraction: 0.9405; feature_fraction: 0.2938; learning_rate: 0.3144; max_depth: 35.7565; min_child_weight: 19.2424; min_split_gain: 0.0839; n_estimators: 149.5511; and num_leaves: 22.1259.

These hyperparameters were meticulously optimized to balance the trade-offs between overfitting and underfitting, ensuring that the models generalize well to unseen data. The use of these specific settings allows the models to capture the nuanced behaviors of different attackers, enhancing the detection accuracy and robustness of the BBS system 104.

Thus, the use of the LightGBM algorithm, with its fast training times and high accuracy, significantly improves the ability for the BBS system 104 to detect various types of attackers effectively. The incorporation of Bayesian optimization for hyperparameter tuning further enhances the performance and efficiency of the models.

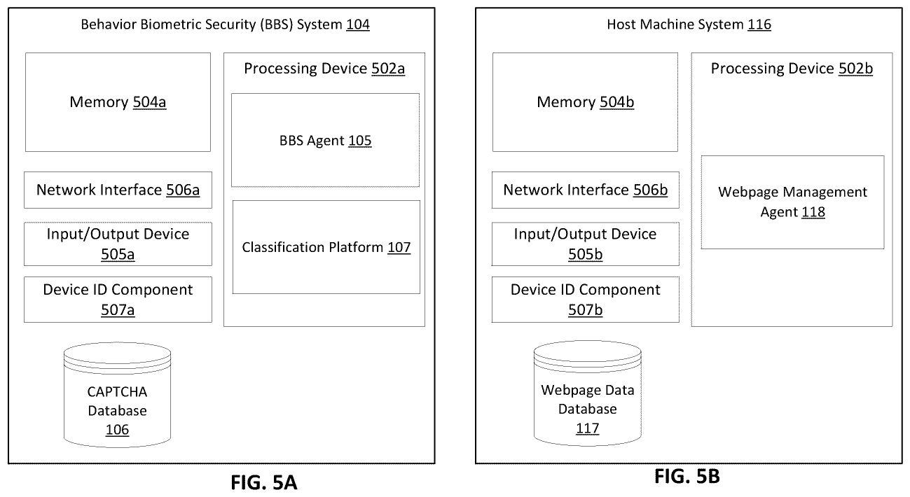

FIG. 5A is a block diagram depicting an example of the BBS system in FIG. 1, according to some embodiments. While various devices, interfaces, and logic with particular functionality are shown, it should be understood that the BBS system 104 includes any number of devices and/or components, interfaces, and logic for facilitating the functions described herein. For example, the activities of multiple devices may be combined as a single device and implemented on a same processing device (e.g., processing device 502a), as additional devices and/or components with additional functionality are included.

The BBS system 104 includes a processing device 502a (e.g., general purpose processor, a PLD, etc.), which may be composed of one or more processors, and a memory 504a (e.g., synchronous dynamic random-access memory (DRAM), read-only memory (ROM)), which may communicate with each other via a bus (not shown).

The processing device 502a may be provided by one or more general-purpose processing devices such as a microprocessor, central processing unit, or the like. In some embodiments, processing device 502a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 502a may include one or more special-purpose processing devices such as an application specific integrated circuit (ASIC), a field programmable gate array (FPGA), a digital signal processor (DSP), network processor, or the like. The processing device 502a may be configured to execute the operations described herein, in accordance with one or more aspects of the present disclosure, for performing the operations and steps discussed herein.

The memory 504a (e.g., Random Access Memory (RAM), Read-Only Memory (ROM), Non-volatile RAM (NVRAM), Flash Memory, hard disk storage, optical media, etc.) of processing device 502a stores data and/or computer instructions/code for facilitating at least some of the various processes described herein. The memory 504a includes tangible, non-transient volatile memory, or non-volatile memory. The memory 504a stores programming logic (e.g., instructions/code) that, when executed by the processing device 502a, controls the operations of the BBS system 104. In some embodiments, the processing device 502a and the memory 504a form various processing devices and/or circuits described with respect to the BBS system 104. The instructions include code from any suitable computer programming language such as, but not limited to, C, C++, C#, Java, JavaScript, VBScript, Perl, HTML, XML, Python, TCL, and Basic.

The processing device 502a executes a classification platform 107 that includes a plurality of predicative and/or AI models that are trained to classify users of client devices as being human users or bot users based on mouse events. Specifically, the classification platform 107 includes and/or executes an solve service A model 108, a solve service B model 109, and a solve service C model 110. The processing device 502a trains, using a first set of training data, the solve service A 108 to determine whether an input dataset includes biometric movement patterns that are indicative of a solve service A bot, and generate an output value (e.g., 0 or 1, no or yes) indicating its determination. The processing device 502a trains, using a second set of training data, the solve service B model 109 to determine whether an input dataset includes biometric movement patterns that are indicative of a solve service B bot, and generate an output value (e.g., 0 or 1, no or yes) indicating its determination. The processing device 502a trains, using a third set of training data, the solve service C model 110 to determine whether an input dataset includes biometric movement patterns that are indicative of a solve service C bot, and generate an output value (e.g., 0 or 1, no or yes) indicating its determination. The first set of training data includes biometric movement data produced by a solve service A bot, the second set of training data includes biometric movement data produced by a solve service B bot, and the third set of training data includes biometric movement data produced by a solve service C bot.

The processing device 502a executes a BBS agent 105 that may be configured to receive a request to authenticate a user of a client device that is requesting access to a webpage. The BBS agent 105 may be configured to provide a security puzzle to the client device responsive to receiving the request. The BBS agent 105 may be configured to acquire an input dataset (e.g., behavioral data) corresponding to a plurality of mouse events associated with an attempt by the user of the client device to solve the security puzzle. The input dataset may include, for example, a plurality of mouse positions (e.g., X and Y coordinates), a plurality of mouse click statuses (e.g., up, down, left click, right click, scroll up, scroll down), and/or timestamps respectively associated with the plurality of mouse events. The BBS agent 105 may be configured to provide the input dataset to the classification platform 107 trained to classify users of client devices 112 as being human users or bot users based on mouse events. The BBS agent 105 may be configured to generate, using the classification platform 107, a report indicating whether the user of the client device 112 is a human user or a bot user.

The BBS agent 105 may be configured to receive the request to authenticate the user of the client device by receiving the request from the host machine 116 (e.g., a web server) that hosts the webpage. The BBS agent 105 may be configured to send, to the host machine 116, a message indicating that the client device 112 should be denied access to the webpage, or send, to the host machine 116, a message indicating that the client device 112 should be allowed access to the webpage.

The BBS agent 105 may be configured to generate the report by detecting, using the classification platform 107, a biometric pattern based on the input dataset; and map, using the classification platform 107, the biometric pattern to a particular attack service of a plurality of attack services.

The BBS agent 105 may be configured to parse the input dataset to generate a parsed dataset. The BBS agent 105 may be configured to group the parsed dataset into a list of tuples respectively indicative of a plurality of different mouse events. The BBS agent 105 may be configured to re-train the one or more models of the classification platform 107 based on the list of tuples to improve an accuracy of the one or more models.

The BBS agent 105 may be configured to further train the models of the classification platform 107 using Internet Service Provider (ISP) information and/or

HTTP_ACCEPT_LANGUAGE header information such that the models of the classification platform 107 can classify the users of client devices 112 as being human users or bot users.

The BBS agent 105 may be configured to split (e.g., parse) the HTTP_ACCEPT_LANGUAGE header information into a plurality of language preferences respectively associated with a plurality of quality factors. The BBS agent 105 then determines whether the plurality of quality factors are in descending order; and either: generates a flag indicating that the plurality of quality factors are in the descending order, or generates a flag indicating that the plurality of quality factors are not in the descending order.

The BBS agent 105 may be configured to check for a presence of the plurality of quality factors in the HTTP_ACCEPT_LANGUAGE header information by searching the HTTP_ACCEPT_LANGUAGE for a delimiter.

The BBS agent 105 may be configured to assign, based on a predefined frequency map of ISPs, a popularity score to the ISP information.

The BBS agent 105 may be configured to generate, based on the input dataset, a plurality of calculations that includes at least one of a straight line distance, a speed, an interaction length, or a number of clicks. The BBS agent 105 then provides the plurality of calculations to the classification platform 107, which in turn, allows the classification platform 107 to consider this information when making decisions.

The BBS system 104 includes a network interface 506a configured to establish a communication session with a computing device for sending and receiving data over the communication network 120 to the computing device. Accordingly, the network interface 506a includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the BBS system 104 includes a plurality of network interfaces 506a of different types, allowing for connections to a variety of networks, such as local area networks (public or private) or wide area networks including the Internet, via different sub-networks.

The BBS system 104 includes an input/output device 505a configured to receive user input from and provide information to a user. In this regard, the input/output device 505a is structured to exchange data, communications, instructions, etc. with an input/output component of the BBS system 104. Accordingly, input/output device 505a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.).

The one or more user interfaces may be internal to the housing of the BBS system 104, such as a built-in display, touch screen, microphone, etc., or external to the housing of BBS system 104, such as a monitor connected to BBS system 104, a speaker connected to BBS system 104, etc., according to various embodiments. In some embodiments, the BBS system 104 includes communication circuitry for facilitating the exchange of data, values, messages, and the like between the input/output device 505a and the components of the BBS system 104. In some embodiments, the input/output device 505a includes machine-readable media for facilitating the exchange of information between the input/output device 505a and the components of the BBS system 104. In still another embodiment, the input/output device 505a includes any combination of hardware components (e.g., a touchscreen), communication circuitry, and machine-readable media.

The BBS system 104 includes a device identification component 507a (shown in FIG. 5A as device ID component 507a) configured to generate and/or manage a device identifier associated with the BBS system 104. The device identifier may include any type and form of identification used to distinguish the BBS system 104 from other computing devices. In some embodiments, to preserve privacy, the device identifier may be cryptographically generated, encrypted, or otherwise obfuscated by any device and/or component of BBS system 104. In some embodiments, the BBS system 104 may include the device identifier in any communication (e.g., container image file, rejection messages, etc.) that the BBS system 104 sends to a computing device.

The BBS system 104 includes a bus (not shown), such as an address/data bus or other communication mechanism for communicating information, which interconnects the devices and/or components of BBS system 104, such as processing device 502a, network interface 506a, input/output device 505a, and device ID component 507a.

In some embodiments, some or all of the devices and/or components of BBS system 104 may be implemented with the processing device 502a. For example, the BBS system 104 may be implemented as a software application stored within the memory 504a and executed by the processing device 502a. Accordingly, such embodiment can be implemented with minimal or no additional hardware costs. In some embodiments, any of these above-recited devices and/or components rely on dedicated hardware specifically configured for performing operations of the devices and/or components.

FIG. 5B is a block diagram depicting an example of the host machine of the environment in FIG. 1, according to some embodiments. While various devices, interfaces, and logic with particular functionality are shown, it should be understood that the client device 102 includes any number of devices and/or components, interfaces, and logic for facilitating the functions described herein. For example, the activities of multiple devices may be combined as a single device and implemented on a same processing device (e.g., processing device 502b), as additional devices and/or components with additional functionality are included.

The host machine 116 includes a processing device 502b (e.g., general purpose processor, a PLD, etc.), which may be composed of one or more processors, and a memory 504b (e.g., synchronous dynamic random-access memory (DRAM), read-only memory (ROM)), which may communicate with each other via a bus (not shown). The processing device 502b includes identical or nearly identical functionality as processing device 502a in FIG. 5a, but with respect to devices and/or components of the host machine 116 instead of devices and/or components of the BBS system 104.

The memory 504b of processing device 502b stores data and/or computer instructions/code for facilitating at least some of the various processes described herein. The memory 504b includes identical or nearly identical functionality as memory 504a in FIG. 5A, but with respect to devices and/or components of the host machine 116 instead of devices and/or components of the BBS system 104.

The processing device 502b may be configured to execute a webpage management agent 118 that is configured to receive a request from a client device 112 to access a webpage that is hosted by the host machine 116. The webpage management agent 118 may be configured to send, to the BBS system 104, a request to authenticate a user of the client device 112 in response to receiving the request from the client device 112 to access the webpage. The webpage management agent 118 may be configured to receive messages from the BBS system 104. If the message indicates that the user of the client device 112 is a bot and/or should be denied access to the webpage, then the webpage management agent 118 may decide to deny the client device 112 the ability to access the webpage. Alternatively, if the message indicates that the user of the client device 112 is a human user and/or should be allowed access to the webpage, then the webpage management agent 118 may decide to allow the client device 112 the ability to access the webpage by sending the webpage to the client device 112.

The host machine 116 includes a network interface 506b configured to establish a communication session with a computing device for sending and receiving data over a network to the computing device. Accordingly, the network interface 506b includes identical or nearly identical functionality as network interface 506a in FIG. 5A, but with respect to devices and/or components of the host machine 116 instead of devices and/or components of the BBS system 104.

The host machine 116 includes an input/output device 505b configured to receive user input from and provide information to a user. In this regard, the input/output device 505b is structured to exchange data, communications, instructions, etc. with an input/output component of the host machine 116. The input/output device 505b includes identical or nearly identical functionality as input/output device 505a in FIG. 5A, but with respect to devices and/or components of the host machine 116 instead of devices and/or components of the BBS system 104.

The host machine 116 includes a device identification component 507b (shown in FIG. 5B as device ID component 507b) configured to generate and/or manage a device identifier associated with the host machine 116. The device ID component 507b includes identical or nearly identical functionality as device ID component 507a in FIG. 5A, but with respect to devices and/or components of the host machine 116 instead of devices and/or components of the BBS system 104.

The host machine 116 includes a bus (not shown), such as an address/data bus or other communication mechanism for communicating information, which interconnects the devices and/or components of the host machine 116, such as processing device 502b, network interface 506b, input/output device 505b, and device ID component 507b.

In some embodiments, some or all of the devices and/or components of host machine 116 may be implemented with the processing device 502b. For example, the host machine 116 may be implemented as a software application stored within the memory 504b and executed by the processing device 502b. Accordingly, such embodiment can be implemented with minimal or no additional hardware costs. In some embodiments, any of these above-recited devices and/or components rely on dedicated hardware specifically configured for performing operations of the devices and/or components.

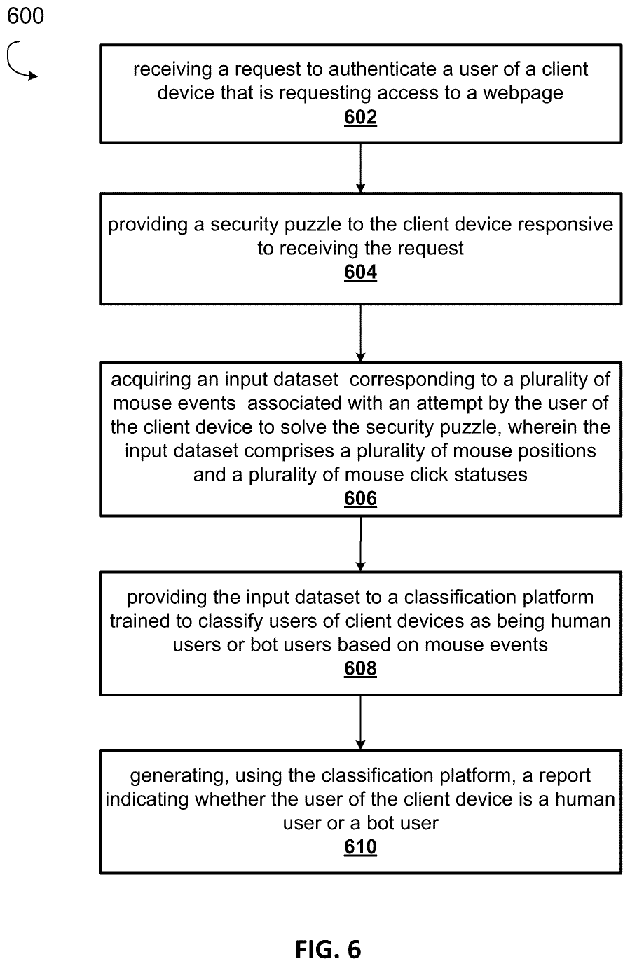

FIG. 6 is a flow diagram depicting a method of using behavioral biometrics and machine learning to identify attackers in a computing environment, according to some embodiments. Method 600 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more blocks of method 600 may be performed by one or more behavioral biometric security, such as BBS system 104 in FIG. 1.

With reference to FIG. 6, method 600 illustrates example functions used by various embodiments. Although specific function blocks (“blocks”) are disclosed in method 600, such blocks are examples. That is, embodiments are well suited to performing various other blocks or variations of the blocks recited in method 600. It is appreciated that the blocks in method 600 may be performed in an order different than presented, and that not all of the blocks in method 600 may be performed.

As shown in FIG. 6, the method 600 includes the block 602 of receiving a request to authenticate a user of a client device that is requesting access to a webpage. The method 600 includes the block 604 of providing a security puzzle to the client device responsive to receiving the request. The method 600 includes the block 606 of acquiring an input dataset corresponding to a plurality of mouse events associated with an attempt by the user of the client device to solve the security puzzle, wherein the input dataset includes a plurality of mouse positions and a plurality of mouse click statuses. The method 600 includes the block 608 of providing the input dataset to a classification platform trained to classify users of client devices as being human users or bot users based on mouse events. The method 600 includes the block 610 of generating, using the classification platform, a report indicating whether the user of the client device is a human user or a bot user.

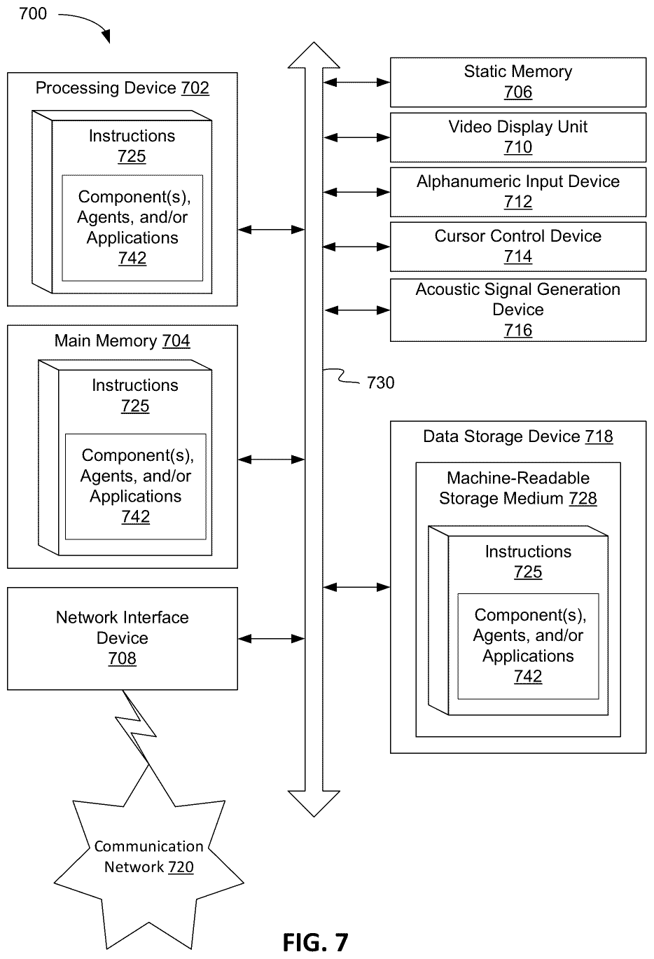

FIG. 7 is a block diagram of an example computing device that may perform one or more of the operations described herein, in accordance with some embodiments. Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include a processing device (e.g., a general-purpose processor, a PLD, etc.) 702, a main memory 704 (e.g., synchronous dynamic random-access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also include one or more special-purpose processing devices such as an application specific integrated circuit (ASIC), a field programmable gate array (FPGA), a digital signal processor (DSP), network processor, or the like. The processing device 702 may be configured to execute the operations described herein, in accordance with one or more aspects of the present disclosure, for performing the operations and steps discussed herein.

Computing device 700 may further include a network interface device 708 which may communicate with a communication network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Data storage device 718 may include a computer-readable storage medium 728 on which may be stored one or more sets of instructions 725 that may include instructions for one or more components/agents/applications 742 (e.g., BBS agent 105, classification platform 107) for carrying out the operations described herein, in accordance with one or more aspects of the present disclosure. Instructions 725 may also reside, completely or at least partially, within main memory 704 and/or within processing device 702 during execution thereof by computing device 700, main memory 704 and processing device 702 also constituting computer-readable media. The instructions 725 may further be transmitted or received over a communication network 720 via network interface device 708.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “providing,” “acquiring,” “generating,” “sending,” “detecting,” “mapping,” “training,” “parsing,” “grouping,” “re-training,” “splitting,” “determining,” “assigning,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the embodiments of the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the embodiments of the present disclosure are not to be limited to the details given herein, but may be modified within the scope and equivalents of the appended claims.

What is claimed is:

1. A method comprising:
receiving a request to authenticate a user of a client device that is requesting access to a webpage;
providing a security puzzle to the client device responsive to receiving the request;
acquiring an input dataset corresponding to a plurality of behavioral biometrics associated with an attempt by the user of the client device to solve the security puzzle;
providing, by a processing device, the input dataset to a classification platform trained to classify users of client devices as being human users or bot users based on behavioral biometrics; and
generating, using the classification platform, a report indicating whether the user of the client device is a human user or a bot user.

2. The method of claim 1, wherein the input dataset comprises a plurality of cursor events and a plurality of timestamps associated with the plurality of cursor events.

3. The method of claim 1, wherein receiving the request to authenticate the user of the client device further comprises receiving the request from a web server that hosts the webpage, and further comprising:
sending, to the web server, a message indicating that the client device should be denied access to the webpage, or
sending, to the web server, a message indicating that the client device should be allowed access to the webpage.

4. The method of claim 1, wherein generating the report further comprises:
detecting, using the classification platform, a biometric pattern based on the input dataset; and
mapping, using the classification platform, the biometric pattern to a particular attack service of a plurality of attack services.

5. The method of claim 1, wherein the classification platform comprises one or more predictive models, and further comprising:
training, using a first set of training data, a first predictive model of the one or more predictive models to detect biometric patterns indicative of a first solve service;
training, using a second set of training data, a second predictive model of the one or more predictive models to detect biometric patterns indicative of a second solve service; and
training, using a third set of training data, a third predictive model of the one or more predictive models to detect biometric patterns indicative of a third solve service.

6. The method of claim 5, further comprising:
parsing the input dataset to generate a parsed dataset;
grouping the parsed dataset into a list of tuples respectively indicative of a plurality of different behavioral biometrics; and
re-training the one or more predictive models based on the list of tuples to improve an accuracy of the one or more predictive models.

7. The method of claim 1, wherein the classification platform is further trained to classify the users of client devices as being human users or bot users based on Internet Service Provider (ISP) information or HTTP_ACCEPT_LANGUAGE header information.

8. The method of claim 7, further comprising:
splitting the HTTP_ACCEPT_LANGUAGE header information into a plurality of language preferences respectively associated with a plurality of quality factors; and
determining whether the plurality of quality factors are in descending order; and either:
generating a flag indicating that the plurality of quality factors are in the descending order, or
generating a flag indicating that the plurality of quality factors are not in the descending order.

9. The method of claim 7, further comprising:
checking for a presence of the plurality of quality factors in the HTTP_ACCEPT_LANGUAGE header information by searching the HTTP_ACCEPT_LANGUAGE for a delimiter.

10. The method of claim 7, further comprising:
assigning, based on a predefined frequency map of ISPs, a popularity score to the ISP information.

11. The method of claim 1, further comprising:
generating, based on the input dataset, a plurality of calculations comprising at least one of a straight line distance, a speed, an interaction length, or a number of clicks, and
providing the plurality of calculations to the classification platform.

12. A system comprising:
a memory; and
a processing device, operatively coupled to the memory, to:
receive a request to authenticate a user of a client device that is requesting access to a webpage;
provide a security puzzle to the client device responsive to receiving the request;
acquire an input dataset corresponding to a plurality of behavioral biometrics associated with an attempt by the user of the client device to solve the security puzzle;
provide the input dataset to a classification platform trained to classify users of client devices as being human users or bot users based on behavioral biometrics; and
generate, using the classification platform, a report indicating whether the user of the client device is a human user or a bot user.

13. The system of claim 12, wherein the input dataset comprises a plurality of cursor events and a plurality of timestamps associated with the plurality of cursor events.

14. The system of claim 12, wherein receiving the request to authenticate the user of the client device further comprises receiving the request from a web server that hosts the webpage, and wherein the processing device is to:
send, to the web server, a message indicating that the client device should be denied access to the webpage; and
send, to the web server, a message indicating that the client device should be allowed access to the webpage.

15. The system of claim 12, wherein to generate the report, the processing device is further to:
detect, using the classification platform, a biometric pattern based on the input dataset; and
map, using the classification platform, the biometric pattern to a particular attack service of a plurality of attack services.

16. The system of claim 12, wherein the classification platform comprises one or more predictive models, and wherein the processing device is to:
re-train, using a first set of re-train data, a first predictive model of the one or more predictive models to detect biometric patterns indicative of a first solve service;
re-train, using a second set of re-train data, a second predictive model of the one or more predictive models to detect biometric patterns indicative of a second solve service; and
re-train, using a third set of re-train data, a third predictive model of the one or more predictive models to detect biometric patterns indicative of a third solve service.

17. The system of claim 12, wherein the processing device is to:
parse the input dataset to generate a parsed dataset;
group the parsed dataset into a list of tuples respectively indicative of a plurality of different behavioral biometrics; and
re-train the one or more predictive models based on the list of tuples to improve an accuracy of the one or more predictive models.

18. The system of claim 12, wherein the classification platform is further trained to classify the users of client devices as being human users or bot users based on Internet Service Provider (ISP) information or HTTP_ACCEPT_LANGUAGE header information.

19. The system of claim 12, wherein the processing device is to:
split the HTTP_ACCEPT_LANGUAGE header information into a plurality of language preferences respectively associated with a plurality of quality factors;
determine whether the plurality of quality factors are in descending order; and either:
generate a flag indicating that the plurality of quality factors are in the descending order, or
generate a flag indicating that the plurality of quality factors are not in the descending order.

20. A non-transitory computer-readable medium storing instructions that, when executed by a processing device, cause the processing device to:
receive a request to authenticate a user of a client device that is requesting access to a webpage;
provide a security puzzle to the client device responsive to receiving the request;
acquire an input dataset corresponding to a plurality of behavioral biometrics associated with an attempt by the user of the client device to solve the security puzzle;
provide, by the processing device, the input dataset to a classification platform trained to classify users of client devices as being human users or bot users based on behavioral biometrics; and
generate, using the classification platform, a report indicating whether the user of the client device is a human user or a bot user.
